(19) United States
(12) Patent Application Publication
(10) Pub. No.: US 2018/0017036 A1
(43) Pub. Date: Jan. 18, 2018

(54) Vortex Wind Power Conversion System

(71) Applicants: Neal Robert Steiner, Los Angeles, CA (US); Steven Isaac Steiner, Los Angeles, CA (US)

(72) Inventors: Neal Robert Steiner, Los Angeles, CA (US); Steven Isaac Steiner, Los Angeles, CA (US)

(21) Appl. No.: 15/208,665

(22) Filed: Jul. 13, 2016

(51) Int. Cl. F03D 1/04; F03D 7/04; F03D 7/02

(52) U.S. Cl. CPC F03D 1/04; F03D 7/0224; F03D 7/04

(57) ABSTRACT

A wind energy device (100) utilizes a cone (102) to concentrate the wind. The inside of the cone (102) has rifling (110) which spirals the wind to more effectively hit the rotor blades (112) adjacent the smaller opening (108) of the cone (102). A convex screen (124) deflects objects from the larger opening (104) of the cone (102). The device has a bottom caudal fin (116) to help direct the wind into the larger opening (104) of the cone (102) as the wind changes direction. The cone (102) can have a top fin (118) as well. The device is equally weight balanced on a shaft (120) and pivots on a bearing (122) to help it rotate effortlessly. This pivot enables maximum efficiency of capturing the wind. The cone (102) can be comprised of sections (136) that open up in a strong wind by hinges (134) and a motor or spring at the front (104) of the cone (102). Solar panels (132) can be placed on the cone (102), the rotor housing (114), the generator (126), and the shaft (120) to generate additional electricity.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

### 1. Field of the Invention

This application relates to wind energy conversion devices and, more particularly, to a system, mechanism, and method utilizing a wind guiding element which narrows in a conical manner to create a vortex to increase the wind velocity by concentrating the wind and utilizing a rifling of kinetic wind energy to create a tornado-like spiral of wind for driving a propeller thereby more efficiently extracting energy from the wind and converting it to usable energy.

### 2. Description of Related Art and Other Considerations

Since early history, people have been harnessing wind power. Wind energy was used to propel boats along the Nile River as early as 5000 B.C. By 200 B.C., simple windmills in China were pumping water, while vertical-axis windmills with woven reed sails were grinding grain in Persia and the Middle East.

Eventually, new methods of using wind energy spread around the world. By the 11^{th} century, people in the Middle East used windmills extensively to produce food. Returning merchants and crusaders carried this idea back to Europe. The Dutch refined the windmill and adapted it for draining lakes and marshes in the Rhine River Delta.

When settlers took this technology to the New World in the late 19^{th} century, they began using windmills to pump water for farms and ranches, grind wheat and corn, cut wood at sawmills, and later to generate electricity for homes and industry. With the development of electricity, wind power found new applications in lighting buildings remotely from centrally generated power stations. Throughout the 20^{th} century, small wind plants, suitable for farms and residences, and larger utility-scale wind farms, that could be connected to electricity grids, were developed.

Industrialization, first in Europe and later in America, unfortunately led to a gradual decline in the use of windmills. The steam engine replaced European water-pumping windmills.

However, industrialization also sparked the development of larger windmills to generate electricity. Called wind turbines, these machines appeared in Denmark as early as 1890. In the 1940s, the largest wind turbine of the time began operating on a Vermont hilltop known as Grandpa's Knob. This turbine was rated at 1.25 megawatts in winds of about 30 mph.

Wind electric turbines remained in use in Denmark into the 1950s but were abandoned due to the availability of cheap oil and low energy prices.

The oil shortages of the 1970s changed the energy picture for the world. It created an interest in alternative energy sources, paving the way for the re-entry of the wind turbine to generate electricity.

The wind turbine technology research & development that followed the oil embargoes of the 1970s refined old ideas and introduced new ways of converting wind energy into useful power. Many of these approaches have been demonstrated in “wind farms” or wind power plants—groups of turbines that feed electricity into the utility grid—in the United States and Europe.

In the 1980s and early 1990s, low oil prices threatened to make electricity from wind power uneconomical. But in the 1980s, wind energy flourished in California partly because of federal and state tax incentives that encouraged renewable energy sources. These incentives funded the first major use of wind power for a public utility's electricity.

While wind energy's growth in the U.S. slowed dramatically after tax incentives ended in the late 1980s, wind energy continued to grow in Europe, partially due to a renewed concern for the environment. This was in response to scientific studies indicating global climate changes resulting from continued use of fossil fuel.

Today, wind-powered generators operate in every size, ranging from small turbines for battery charging at residences to large, near-gigawatt-size offshore wind farms that provide electricity to national electric transmission systems. Wind energy is the world's fastest-growing energy source and will power industry, businesses, and homes with clean, renewable electricity for many years to come.

Advantages and Challenges of Wind Energy:

In general, wind energy offers many advantages, which explains why it's the fastest-growing energy source in the world. Research efforts are aimed at addressing the challenges to greater use of wind energy.

Advantages:

Wind energy is powered by the wind, so it's a clean fuel source. Wind energy doesn't pollute the air like power plants that rely on fossil fuels such as coal or natural gas. Wind turbines don't produce atmospheric emissions that cause acid rain or greenhouse gasses.

Wind energy is a domestic source of energy, produced in the United States. The nation's wind supply is abundant.

Wind energy relies on the renewable power of the wind, which can't be used up. Wind is actually a form of solar energy; winds are caused by the heating of the atmosphere by the sun, the rotation of the earth, and the earth's surface irregularities.

Wind energy is one of the lowest-priced renewable energy technologies available today, costing between 4 and 6 cents per kilowatt-hour, depending upon the wind resource and project financing of the particular project.

Wind turbines can be built on farms or ranches, thus benefitting the economy in rural areas, where most of the best wind sites are found. Farmers and ranchers can continue to work the land because the wind turbines use only a fraction of the land. Wind power plant owners make rent payments to the farmer or rancher for the use of the land.

Challenges:

Wind power must compete with conventional power generation sources (i.e. coal, natural gas, etc.) on a cost basis. Depending on how much wind occurs at a wind site, the wind farm may or may not be cost competitive. Even though the cost of wind power has decreased dramatically in the past 10 years, the technology requires a higher initial investment than fossil-fueled generators.

Good wind sites are often located in remote locations, far from cities where the electricity is needed. Transmission lines must be built to bring the electricity from the wind farm to the city.

Wind resource development may compete with other uses for the land and those alternative uses may be more highly valued than electricity generation.

Although wind power plants have relatively little impact on the environment compared to other conventional power plants, there is some concern over the noise produced by the rotor blades, aesthetic (visual) impacts, and sometimes birds have been killed by flying into the rotors. Most of these problems have been resolved or greatly reduced through technological development or by properly siting the wind plants.

Environmental Impacts and Siting of Wind Power Projects:

Wind power is a renewable, low-carbon footprint energy supply option. When properly sited, wind projects provide a net environmental benefit to the communities in which they operate and to the nation overall. Increased use of wind power will cleanly wean the United States off of its dependence on foreign oil.

Wind energy can have adverse environmental impacts. Wind projects have the potential to reduce, fragment, or degrade habitat for wildlife, fish, and plants. Turbine blades and towers can pose a threat to flying wildlife like birds (for example, the sage-grouse) and bats.

Wind Technologies:

Wind energy technologies use the energy in wind for practical purposes, such as generating electricity, charging batteries, pumping water, and grinding grain. Mechanical or electrical power is created through the kinetic energy of the wind. Mathematically speaking, the wind power available is proportional to the cube of its speed. For example, this means that the power available to a wind generator increases by a factor of eight if the wind speed doubles.

Wind turbines harness the power of the wind and use it to generate electricity. Simply stated, a wind turbine works the opposite of a fan. Instead of using electricity to make wind like a fan, wind turbines use wind to make electricity.

The turbine's blades are similar to the propeller blades on an airplane. The rotor of the turbine rotates as the rotor blades generate lift from the passing wind. The rotor is connected to the main shaft. This rotating action then turns a generator, which creates electricity.

When the wind blows, a pocket of low-pressure air forms on the downwind side of the blade. The low-pressure air pocket then pulls the blade toward it, causing the rotor to turn. This is called lift. The force of the lift is actually much stronger than the wind's force against the front side of the blade, which is called drag. The combination of lift and drag is what causes the rotor to spin.

Since the wind's speed typically increases with height above ground (due to decreasing friction with the ground), wind turbines usually are mounted on a tower to capture more energy. At 100 feet (30 meters) or more above ground, they can take advantage of faster and less turbulent wind.

For the best utilization of current wind turbine designs, they should be placed where wind speeds reach 16-20 miles per hour and are at a height of 50 meters. It is also important that utility-scale power plants are located near existing power lines and in the windiest sites available.

Wind energy technologies can be used as stand-alone applications, connected to a utility power grid, or even combined with a photovoltaic system. For utility-scale sources of wind energy, turbines are usually built close together to form a wind farm that provides bulk power. Several electricity providers use wind farms to supply power to their customers, including Xcel Energy, MidAmerican Energy, and Basin Electric.

Stand-alone turbines are typically used for water pumping or communications. However, homeowners and farmers in windy areas can also use small wind systems to generate electricity.

Wind Turbine Design:

There are different styles and different sizes of wind turbines to accommodate different needs. The most common style, large or small, is the “horizontal-axis design” (with the axis of the blades horizontal to the ground). On this turbine, two or three blades spin upwind of the tower.

Less common are the vertical-axis turbines: the Savonius and the Darrieus. The Darrieus turbine was invented in France in the 1920s and is often described as looking like an eggbeater. It has vertical blades that rotate into and out of the wind. The Savonius turbine is S-shaped if viewed from above. This drag-type turbine turns relatively slowly, but yields a high torque. It is useful for grinding grain, pumping water, and many other tasks, but its slow rotational speeds are not optimal for generating electricity.

Small wind turbines are used for providing power off the grid, and range from very small, 250-watt turbines designed for charging batteries on a sailboat to 50-kilowatt turbines that power dairy farms and remote villages. Like old farm windmills, they have tail vanes that keep them oriented into the wind.

Large wind turbines, used by utilities or independent generators to provide power to a grid, range from 100 kilowatts up to the enormous multi-megawatt machines that are being tested in Europe. Large turbines sit on towers that are up to 100 meters tall and have blades that range from 30 to 60 meters long. Utility-scale turbines are usually placed in groups or rows to take advantage of prime windy areas. Wind farms like these can consist of a few or hundreds of turbines, providing enough power for whole towns.

Prior Art Comparisons:

U.S. Pat. No. 4,516,907 to Edwards (1985) has a bell shaped opening that is not symmetrical, but flat on the bottom. This design is less efficient than a symmetrical shape to direct the wind. Edwards' device does not have an environmentally friendly bird deflector and there is no rifling in the device. His apparatus requires a motor to move the device to face the wind direction as opposed to using an external fin to more efficiently help move the chamber. There are no solar panels on the device to produce additional electrical power.

U.S. Pat. No. 6,246,126 B1 to Van Der Veken et al. (2001) does not have an environmentally friendly bird deflector or solar panels on the device. Van Der Veken's apparatus is open at both ends and is shaped like a cylinder. There is no fin to assist moving the device to face the wind direction and there is no rifling inside the apparatus.

U.S. Pat. No. 7,116,006 B2 to McCoin (2006) needs a tall tower to capture the wind and release the wind below the vertical rotors. The rotors are vertical and there is no focus with the apparatus to increase wind pressure. The device is not symmetrical and there is no rifling in the device. There are neither solar panels on the device nor a bird deflector.

U.S. Pat. No. 7,215,037 B2 to Scalzi (2007) has the wind only hit a fraction of the blades at a time. The concentrator is not cone shaped and not as efficient. There is no fin to automatically maneuver the front of the device to face the wind direction. The protective screen is flat so that objects would get stuck on the front end and not slide off to the sides. There is no rifling in the device. There is loss of wind energy (not as efficient) as the wind hits the side of the intake before curving around the inside of the housing before the wind pushes the rotors.

U.S. Pat. No. 7,220,096 B2 to Tocher (2007) utilizes a vacuum to move the rotor. There is no environmentally friendly bird deflector, nor cone to concentrate the wind. There is no rifling in the device and no passive method (i.e. fin) to move the apparatus to face the wind.

U.S. Pat. No. 7,364,399 B2 to Stiig et al. (2008) does not have a cone shape to concentrate the wind. There is no rifling of the device and no fin to align the device to face the wind. The design of this device depends on a tall structure which would be unstable in strong winds. This is a vertical wind generator.

U.S. Pat. No. 7,479,709 B2 to Hsiung et al. (2009) does not have rifling to create a cyclone effect nor does it have solar panels. There is no balancing of the apparatus between the front and back for easy maneuvering of the device into the wind direction. There is no environmentally friendly screen at the front of the device to prevent birds and other flying debris from adversely affecting the apparatus.

U.S. Pat. No. 7,615,883 B2 to Meheen (2009) has a flat screen to keep debris out, but is not convex to help move items out of the path of the inlet. There is no rifling in the device, and the inlet is flat and not conical so it would not intake as much wind. There are no solar panels on the apparatus to generate additional electrical power. The belt is less energy efficient due to the friction of the belt on the gears.

U.S. Pat. No. 7,728,455 B2 to Branco (2010) is stationary and is dependent on being attached to a building. The wind unit cannot rotate to face the wind since it is attached to a building. There are no solar panels to generate additional electrical power and no rifling in the device.

U.S. Pat. No. 7,811,048 B2 to Allaei (2010) does not have the device equally balanced on the support structure and the fin is too small to have the wind push against the fin to keep the front of the device facing the wind. There is no rifling in the apparatus. The device and hollow column are not as energy efficient as the wind needs to travel a longer distance down the hollow column and needs more force to produce wind energy. This is not efficient for low wind areas. There are no solar panels on the outside to generate additional electrical power. It does have a screen to deflect birds, but it is not a convex screen so debris can hit the screen and stick to the screen, reducing the wind force going into the rotors.

U.S. Pat. No. 7,915,751 B2 to Su et al. (2011) does not contain a cone, rifling, solar panels, or a convex screen bird protector.

U.S. Pat. No. 8,025,480 B1 to King (2011) only focuses on the blade of a wind turbine. There is no cone, no rifling, nor a fin to control the wind direction. There is no balancing of the device on the shaft nor solar panels to generate additional electrical power.

U.S. Pat. No. 8,084,880 B2 to Botan et al. (2011) is fixed concentrator and is not rotatable. One embodiment is on a platform, but there is no fin to help guide the device into the direction of the wind. There is also not a balancing of the apparatus on the shaft and there is no rifling in the device. There are no solar panels on the device and no environmentally friendly bird protector.

U.S. Pat. No. 8,221,072 B2 to Kapich (2012) has a device that is shaped like a cylinder so the wind concentration is not efficient. There is no rifling in the device and it requires a tower for the system to work. There are no solar panels to generate additional electrical power. There is no balancing of the apparatus on the tower.

U.S. Pat. No. 8,257,019 B2 to Cironi et al. (2012) does not have rifling or solar panels on the device. There is no fin and balancing system to easily move the apparatus into the wind. There is no environmentally friendly bird protector screen.

U.S. Pat. No. 8,362,637 B2 to Kawas et al. (2013) is not rotatable so if the wind changes direction, the wind power is not maximized. There is no rifling, it is not a cone shape, and there is no fin since it does not rotate. The device captures only a fraction of the wind at one time.

U.S. Pat. No. 8,546,971 B2 to Tsitron (2013) is a vertical axis wind power and is not cone shaped. This device only pushes wind up to the rotor blades, but does not concentrate or speed up the wind via a cone. There is no rifling, no fin, nor balancing along a horizontal axis. Bird protection devices are not most optimal as birds or other objects can move past the inlet (see FIGS. 23 and 24) and still harm the birds and adversely affect the performance of the rotors.

U.S. patent application publication 2009/0280009 A1 to Brock (2009) does not have a fin and the apparatus does not balance to automatically rotate into the wind. The larger end of the device is at the back end of the wind flow, not the front end of the device, so the wind concentration is minimal. There are no solar panels on the device, and there is no rifling to direct the wind to efficiently hit the large part of the rotor blades. There is no environmentally friendly bird protective screen. The device does not open up in strong winds to prevent the wind from damaging the apparatus.

### SUMMARY OF THE INVENTION

These and other problems are successfully addressed and overcome by the present invention including the following advantages thereof.

The benefits of the wind power device are that it works in low, medium, or high wind velocities. Rifling, like the arrangement of spiral groves inside a gun barrel to make the projectile spin in a rotary motion when fired, inside the wind power device increases and directs the wind force onto the widest part of the rotor blades. This rifling more effectively turns the rotor blades, making it more efficient in converting wind power into electricity. The device is self-guided to the direction of the wind for maximum wind efficiency. This device can be smaller than the conventional wind power devices and produce the same power output as a larger conventional wind power device. This is due to the efficiency of the conical wind concentrator and the rifling, so it is less expensive than the larger conventional wind power devices. It can also have a lower stance than the conventional wind power devices so it would not be hazardous to birds and would not be so unsightly, obtrusive, and environmentally unfriendly.

The cone causes a Venturi/Bernoulli principle effect as the cone acts as a wind concentrator. The wind pressure increases as it flows from the larger front entrance to the smaller back end of the cone. In the smaller end of the cone, the air pressure decreases and the wind speed increases as it flows thru the narrow opening containing the rotor blades. This increase in speed causes the rotor to move with more wind speed than if the cone was absent.

There is rifling inside the cone. Rifling is defined as the arrangement of spiral groves inside a gun barrel to make the projectile spin in a rotary motion when fired. The rifling can be spiral indentations or ridges on the inside of the cone to modify the air flow from straight to a spiral spin in either a clockwise or counterclockwise direction. The rifling inside the cone spirals the wind in a clockwise or counterclockwise direction to spiral the wind like the wind in a tornado.

The orientation of the rotor blades would be in concert with the orientation of the rifling to ensure the spiraled wind hits the maximum surface of the rotor blades. As the wind moves through the cone, the rifling causes the wind to twist or spin in a certain direction like a tornado. The modified spiral air flow causes the wind to be focused on the widest part of the rotor blades so that the wind will hit the widest part of the rotor blades. The wind hits the widest part of the blades straight on as opposed to hitting at an angle like a regular propeller. This “direct” hit will exert more force on the rotor blades and move the rotor more efficiently due to the rifling. This translates into a more efficient use of the wind to generate more power than if the wind came straight on. Therefore a smaller wind turbine can produce the same power output as a larger, conventional wind turbine. This contributes to a smaller footprint on the environment and a lower cost to produce this smaller wind turbine.

The blades of the rotor are mounted as either fixed-angle or adjustable-angle. This enables the rotor blades to modify their angle of incidence to adjust to wind pressure and speed in the cone so as to get the maximum efficiency of the wind.

The diameter of the rotor blades are slightly smaller than the diameter of the small end of the cone. This is to prevent the blades from coming in contact with the smaller end of the cone.

The cone and rotor housing will be on a pivot to maneuver easily to face the wind as the wind changes direction. The cone and motor housing pivots on the shaft and is weight balanced between the larger front of the cone and the combined back end of the cone and rotor housing so it can pivot easily as the wind changes direction. This balancing reduces the need for external support of the structure as well as for motor-assisted turning of the wind power device. The balancing enables the front of the cone to more easily face the wind as there is less friction on the shaft when the cone and motor housing rotate.

The pivoting is also achieved by a caudal fin on the back of the cone and motor housing. This caudal fin creates a larger surface for the wind to push against to catch the wind direction, rotate the cone, and help align the larger front of the cone with the oncoming direction of the wind. The external caudal fin at the back of the motor housing allows for a quicker alignment of the front of the cone to face the oncoming wind as the wind changes direction. This rotation of the device is to get the maximum wind funneling into the cone. The caudal fin is similar to the back vane on a weather vane or old farm windmill.

To reduce and eliminate the threat to the environment, there is a semi-flexible, convex mesh screen at the front end of the cone that prevents birds or other flying items from entering the cone and jamming the rotor blades and subsequently the generator. The convex shape enables objects to slide off the mesh screen. Wind borne debris would fall away and birds would not be severely injured.

The cone and mesh have colors on the external surfaces so that birds would see the front screen or the cone and avoid the device, thus not harming the birds.

There can be an additional upper fin at the back of the rotor housing to more quickly face the cone into the direction of the wind.

There can be solar panels on the cone and the structure to generate additional electrical energy.

The wind power device can be arranged in a wind farm to have multiple wind power devices harness the wind.

The cone can be hinged at the larger front end in case of strong winds. The hinges are at the front end of the cone and, with motor or mechanical assistance, the cone would open like flower petals. If the wind to too strong, the cone opens up to more resemble a cylinder than a cone, and the strong wind does not increase pressure in the cone or damage the cone or rotor. This allows a strong wind to pass through the device without damaging the device or its components.

These and other advantages of one or more aspects will become apparent from a consideration of the ensuing description and accompanying drawings.

Accordingly, a wind energy conversion device comprises a mechanism and method to generate electricity from wind power. In one embodiment, the device is cone shaped to concentrate the wind to drive the rotor blades. The inside of the cone has rifling which directs the wind in a specific spiral direction enabling the wind to hit the rotor blades more effectively. The device has a caudal fin to help direct the wind into the larger opening of the conical shape. It is balanced on a support structure to help it effortlessly rotate to face the wind. In a strong wind, the cone can open up like flower petals. Solar panels can be on the cone and support structure to generate additional electricity. There is a convex screen at the front opening of the cone to deflect birds and other flying objects away from the rotors and generator.

### BRIEF DESCRIPTION OF THE DRAWINGS

In the drawings, closely related figures have the same number but different alphabetic suffixes.

FIG. 1 shows a side view of a prior art device and how conventionally the wind is inefficiently directed at a propeller at an angle.

FIG. 2 illustrates a side view of a preferred embodiment of the Wind Power Vortex device.

FIG. 3 depicts a front view of the Wind Power Vortex device embodiment shown in FIG. 2.

FIG. 4 shows a side view of the Wind Power Vortex device embodiment shown in FIG. 2 depicting the tornado/vortex effect of rifling combined with the cone structure and the effect this has on the wind as the wind moves through the cone.

FIG. 5 illustrates a side view of the Wind Power Vortex device embodiment shown in FIG. 2 showing the effects of the cone concentrating the wind into the vortex and the rifling causing the cyclone effect on the wind to effectively move the rotor blades more than that as depicted in FIG. 1.

FIG. 6 illustrates an additional embodiment's side view of the Wind Power Vortex device that includes solar panels on the cone, rotor housing, electric motor housing, and support structure of the wind power device.

FIG. 7 illustrates a side view of an additional or second embodiment of the Wind Power Vortex device with an additional upper fin to help direct the wind power conversion device to face into the wind.

FIG. 8 shows a side view of an additional or third embodiment of the Wind Power Vortex device showing the hinged upper and side sections of the cone in their down or collapsed position that swing open in case of high velocity winds.

FIG. 9 illustrates a side view of an additional or third embodiment of the Wind Power Vortex device as seen in FIG. 8 showing the hinged upper and side sections of the cone that have swung open and are in their deployed or expanded position due to high velocity winds.

FIG. 10 shows a back view of an additional or third embodiment of the Wind Power Vortex device as seen in FIG. 8 showing the hinged upper and side sections of the cone in their down or collapsed position.

FIG. 11 illustrates a back view of an additional or third embodiment of the Wind Power Vortex device as seen in FIGS. 8 and 10 showing the hinged upper and side sections of the cone that have swung open and are in their deployed or expanded position due to high velocity winds.

FIG. 12 shows the Wind Power Vortex device as seen in FIG. 2 deployed in a wind farm where there are multiple Wind Power Vortex devices.

### DRAWINGS

The following reference numerals are used in conjunction with the drawings.

| # | PART NAME |
|---|---|
| 10 | Prior Art Device |
| 12 | Rotor Blade Assembly |
| 14 | Blades with Angled Formation |
| 16 | Generator |
| 18 | Wind |
| 18A | Wind Hitting Blades 14 |
| 100 | Wind Power Device |
| 102 | Cone |
| 104 | Large Opening or Entrance |
| 106 | Throat |
| 108 | Small Opening or Exit |
| 110 | Rifling |
| 112 | Rotor Blades |
| 114 | Housing |
| 116 | Fin (Lower) |
| 118 | Fin (Upper) |
| 120 | Shaft |
| 122 | Pivot Bearing |
| 124 | Mesh Screen |
| 126 | Generator |
| 128 | Base |
| 130 | Wind |
| 130A | Spiraling Wind |
| 130B | Wind Hitting Blades 112 |
| 132 | Solar Panels |
| 134 | Hinges with Springs and/or Motors |
| 136 | Cone Sections |

### DETAILED DESCRIPTION OF THE PREFERRED EMBODIMENTS

System Overview:

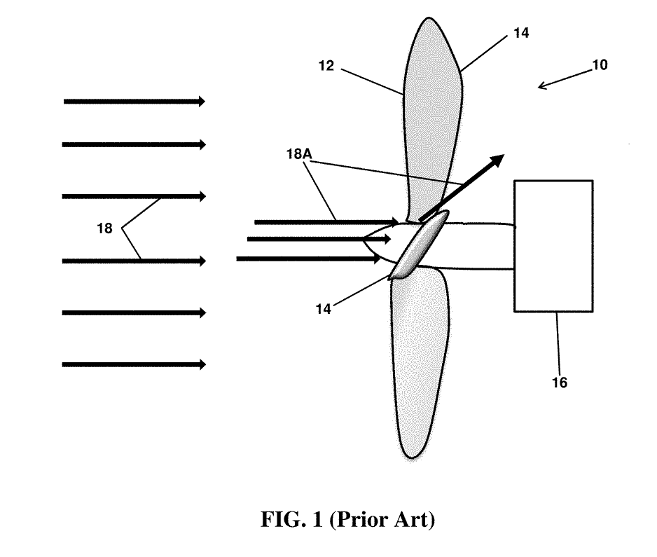

FIG. 1 shows a side view of the prior art device 10 comprising a rotor blade assembly 12 of blades 14 having an angled formation. Rotor blade assembly 12 is coupled to a generator 16. Wind 18 is illustrated as coming from left to right in FIG. 1 and hitting rotor blades 14. Wind 18 thus directly hits rotor blades 14 as denoted by indicium 18A and glances off rotor blades 14 at an angle as influenced by their angled formation. Because no direction is provided to wind 18, this prior art formulation does not enable wind 18 to hit the maximum face of rotor blades 14.

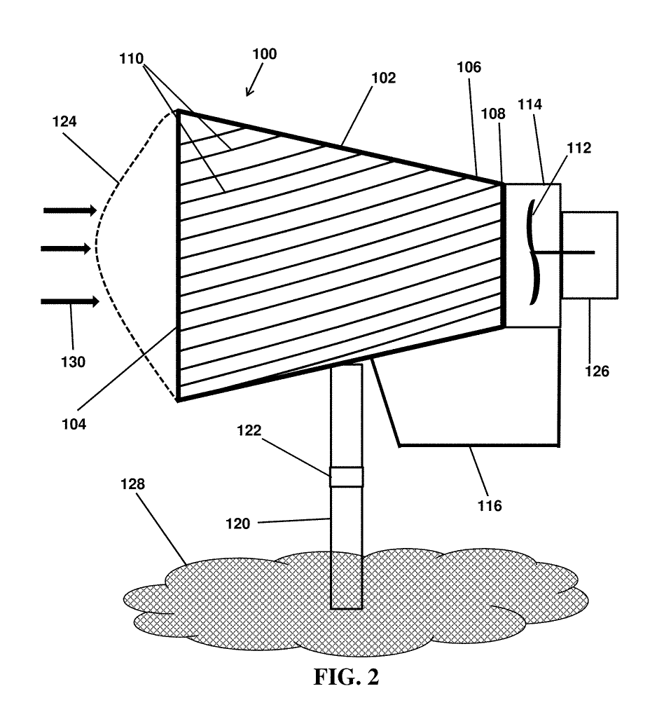

Reference is now made to the first preferred embodiment of the inventive vortex wind power conversion system, which is illustrated in FIGS. 2-5 and which shows the side view of a wind power device 100. FIG. 2 shows a side view of wind power device 100. Wind 130 is illustrated as coming from left to right. Wind power device 100 comprises a cone 102 which is open at both ends. The ends are configured to form a large opening or entrance 104 in cone 102's front or entry end and a small opening or exit 108 in cone 102's back or exit end. As cone 102 decreases in diameter from large entrance 104 to small exit 108, there is a throat 106 which has a diameter of greater dimension than that of exit 108 and is before exit 108. The transition from entrance 104 to exit 108 is essentially smooth and gradual. Nonetheless, the inside or interior of cone 102 is provided with rifling 110 which extends and runs between openings 104 and 108. Wind 130 flows into large front opening 104 of cone 102, becomes concentrated, and builds wind pressure as it flows through cone 102 towards small back end 108 of cone 102.

As wind 130 flows through cone 102 and gets closer to the small exit 108 of cone 102, the wind pressure decreases as the wind speed increases. Rifling 110 runs along the inside of cone 102 from the large front 104 to the small back 108 of cone 102. Rifling 110 can either be indents in the inside of cone 102 like the barrel of a rifle or can be raised ridges along the inside of cone 102. The rotor blades 112 are positioned adjacent to the small exit opening 108 and are housed within a housing 114. A fin 116 located at the lower back end of cone 102 acts like a caudal fin on a fish or like a weather vane. Cone 102 is supported on a shaft 120 having a pivot bearing 122. Shaft 120 has a base 128 to enable it to contact the ground or a platform or a structure. A protective convex screen 124 is secured to cone 102 at its large opening 104 and preferably is selected as to be environmentally friendly. Rotor blades 112 are attached to a generator 126 for conversion into electricity.

In the operation as presently described in FIGS. 2-5, wind (as designated by indicium 130) flows into large opening 104 of cone 102 and becomes concentrated as it flows through cone 102 toward small back end 108 of cone 102. Wind 130 enters into cone 102 and builds pressure. As wind 130 flows through cone 102 from large opening 104 to small opening 108, the wind pressure deceases as the wind speed increases. Rifling 110, which runs along the inside of cone 102, causes wind 130 to move in either a clockwise or counterclockwise direction (i.e. as shown by indicium 130A) and to spiral to resemble a cyclone/tornado.

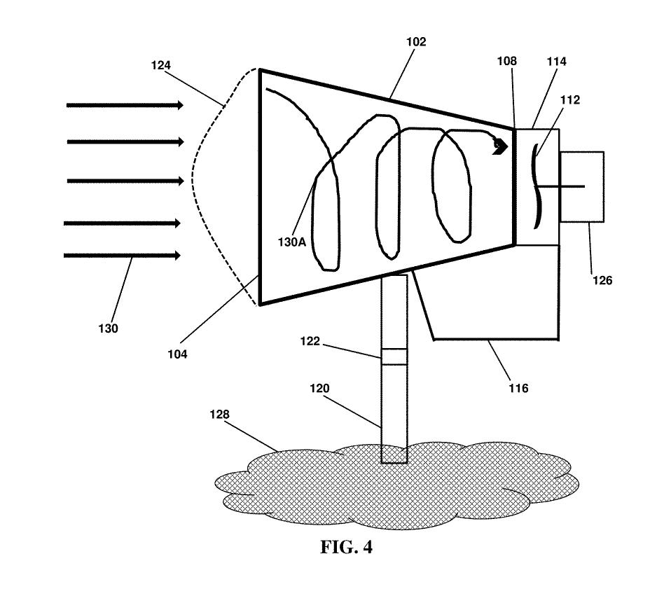

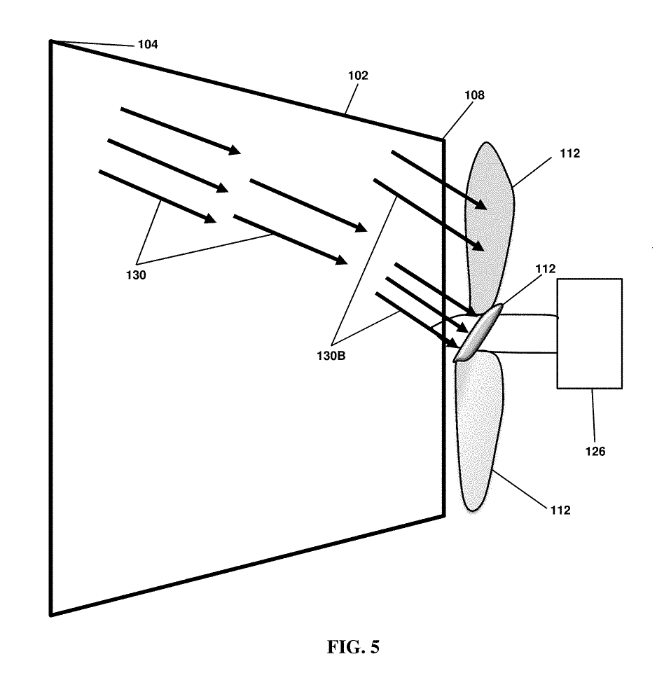

FIGS. 4 and 5 display the effect on wind 130 by rifling 110 inside cone 102 which concentrates and cyclones wind 130 so that wind 130 more effectively hits the maximum surface of rotor blades 112. Rifling 110 spirals wind 130 to spin like a tornado so that wind 130 hits the maximum surface of rotor blade 112 straight on as distinguished from the prior art where, as depicted in FIG. 1, the wind glances off rotor blades 14 at an angle. Accordingly with reference to FIG. 5, wind 130 enters cone 102 and rifling 110 forces wind 130 to rotate in either a clockwise or counterclockwise direction. As shown in FIG. 5, this causes wind 130 to hit the wider part of rotor blades 112.

The diameter of rotor blades 112 are slightly smaller than the diameter of small end 108 of cone 102. This is to ensure the maximum force of wind 130 exiting cone 102 is directed at rotor blades 112. If rotor blades 112's diameter is too small, wind 130 would rush past the tops of rotor blades 112 and the wind power conversion would not be as efficient. If rotor blades 112's diameter was larger than small exit 108's diameter, wind 130 would hit only part of rotor blades 112 and the wind power conversion also would not be as efficient.

In addition the fact that the diameter of rotor blades 112 are slightly smaller than the diameter of small end 108 of cone 102 is to prevent rotor blades 112 from coming into contact with the inside of small end 108 of cone 102 and causing any damage or reducing the efficiency of rotor blades 112. Alternately expressed, rifling 110 causes wind 130 (as depicted by indicia 130B in FIG. 5) to hit more of the surface of each rotor blade 112 in rotor housing 114 adjacent to cone small back end 108 than if wind 130 were coming straight into the rotor blades as in the prior art, e.g., as shown in FIG. 1.

Accordingly, as rotor blades 112 are caused to rotate when struck by wind 130, their rotation is transmitted to generator 126, thereby enabling the wind power to be better converted into electricity. Given the same volume and speed of wind 130, the present invention is more effective and efficient than the prior art.

Rotor blades 112 are mounted as fixed-angle or adjustable-angle on the rotor. This enables rotor blades 112 to modify their angle of incidence to adjust to wind pressure and speed in cone 102 so as to get the maximum efficiency of wind 130.

Mesh screen 124 is visible to flying creatures such as birds. If an object flies into mesh screen 124, the object will strike mesh screen 124 and roll off away from larger front opening 104 of cone 102.

Fin 116, as previously described as located at the lower back end of cone 102, acts like a caudal fin on a fish or like a weather vane. Accordingly, as the direction of the wind changes, fin 116 will cause cone 102 to rotate and change direction and, thereby, have large front end 104 of cone 102 face into the direction of oncoming wind 130. The rotation of cone 102, about pivot bearing 122, provides wind power device 100 with a maximum efficiency for capturing the wind.

FIG. 2 shows the preferred embodiment's side view of cone 102. As is depicted in FIG. 2, cone 102 is equally weight balanced on shaft 120 so that the weight of the front half of cone 102 including mesh screen 124 are equal to the combined weight of the back half of cone 102, fin 116, rotor blades 112, and generator 126 for electricity conversion. This equal balance on shaft 120 reduces the need for any extra support or a bigger structure, which in turn makes the device more cost effective. This equal balancing avoids the need for any mechanical or electric controller to turn cone 102.

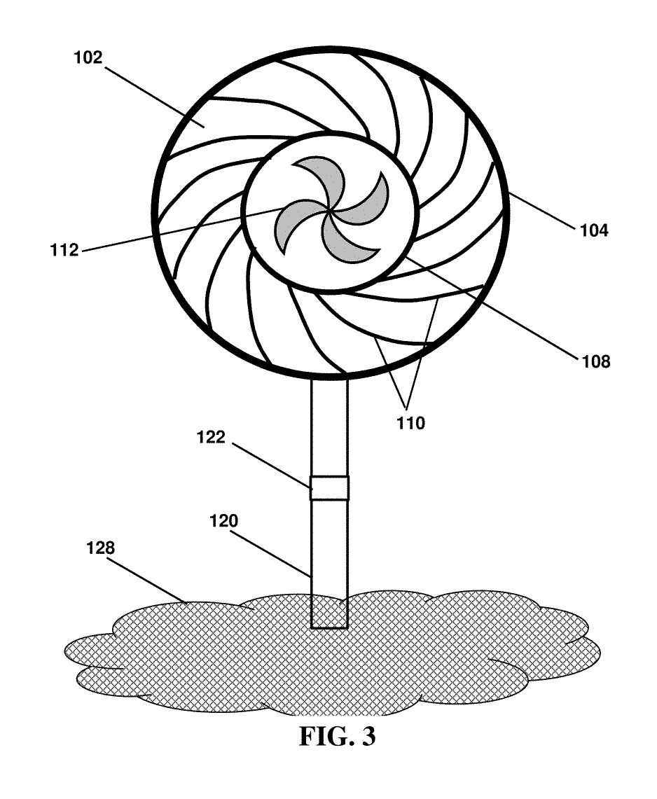

FIG. 3 shows a front view of the wind power device embodiment's cone 102 depicting larger front 104 of cone 102, looking from front to back of cone 102. Wind 130 enters larger front 104 of cone 102. The air flow is modified by rifling 110 to move wind 130 in either a clockwise or counterclockwise direction and resemble a cyclone/tornado. In FIG. 3, rifling 110 directs wind 130 in a clockwise direction although a similar wind movement would occur if the rifling were constructed so as to move the wind in a counterclockwise direction.

Wind 130 is concentrated as it flows from larger front 104 of cone 102 to smaller back end 108 of cone 102. Because of the design of cone 102, the wind concentration (indicium 130 in FIGS. 4 and 5) initially increases the wind pressure and then subsequently the wind speed as wind 130 flows from large front 104 of cone 102 and then out of small exit 108 of cone 102. The wind concentration, along with rifling 110 of wind 130 in cone 102, causes the vortex and cyclone effects on wind 130. Rifling 110 thus causes wind 130 to hit more of the surface of rotor blades 112 than if the wind was coming straight into rotor blades 112. In this example, the large surface of rotor blades 112 are aligned to the direction of rifling 110 for maximum efficiency.

FIG. 4 shows a side view of the wind power device embodiment displaying the effect on the wind of rifling 110 inside cone 102. The wind direction is coming from left to right in FIG. 4. Note the illustration of FIG. 4 has hidden rifling 110 in cone 102 in order to reveal the effect on wind 130A by rifling 110. Cone 102 causes an increase in wind pressure and then subsequently an increase in wind speed as wind 130 moves to small back exit 108 of cone 102. As wind 130 enters cone 102, rifling 110 forces wind 130A to rotate in either a clockwise or counterclockwise direction, depending on the orientation of rifling 110. This causes wind 130A to hit the widest part of rotor blades 112.

FIG. 5 shows a side view of the wind power device embodiment's cone 102 and the effects of cone 102 and rifling 110 on the wind. The wind direction is coming from left to right in FIG. 5. The combination of cone 102 and rifling 110 concentrates and cyclones wind 130 so that wind 130B more effectively hits the maximum surface of rotor blades 112. Rifling 110 spirals the wind so that the wind hits the maximum surface of rotor blades 112 straight on versus the prior art where the wind ineffectively glances off rotor blades 112 at an angle. Given the same volume and speed of the wind, the proposed combination of cone 102 and rifling 110 is more effective and efficient than the prior art.

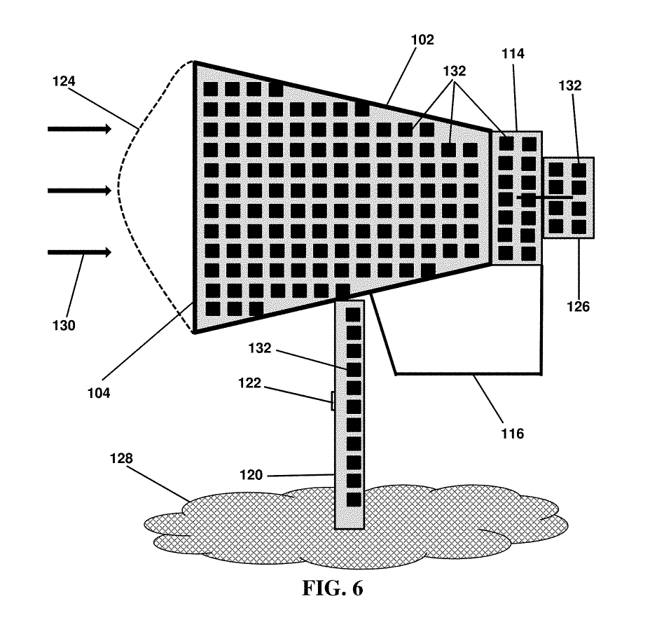

Reference is now made to an additional embodiment of the present invention with regard to FIG. 6 showing a side view of the wind power device embodiment that includes solar panels on its components such as cone 102, rotor housing 114, electric generator housing 126, and shaft structure 120. The wind direction is coming from left to right in FIG. 6. If wind 130 was not producing enough force to drive rotor blades 112 positioned at back end 108 of cone 102 or if there was the need for additional electrical power, a solar panel or solar panels 132 can be on the top and sides of cone 102, the outside of rotor housing 114, the outside of electric generator housing 126, and shaft 120. Solar panels 132 would provide additional electric power in case of very low wind or non-existent wind.

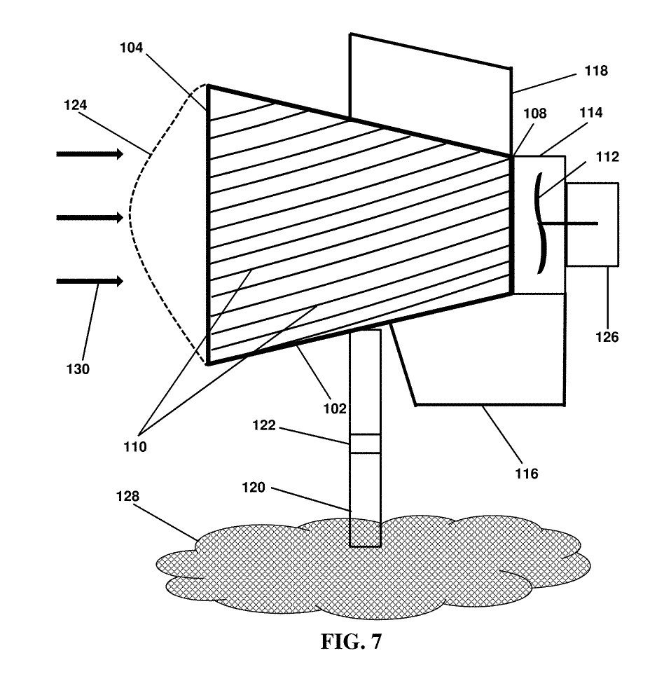

Reference is now made to an additional embodiment of the present invention with regard to FIG. 7 showing a side view of the wind power device embodiment that includes a top fin 118 at the top of cone 102 to help wind 130 guide cone 102 into the direction of wind 130. The wind direction is coming from left to right in FIG. 7. Top fin 118 at the top of cone 102 would help align large front opening 104 of cone 102 into the direction of the wind. Wind 130 would push top fin 118 and subsequently align cone 102 into the direction of the wind to get the maximum wind force to go into large front opening 104 of cone 102. Top fin 118 would be in addition to or instead of bottom fin 116.

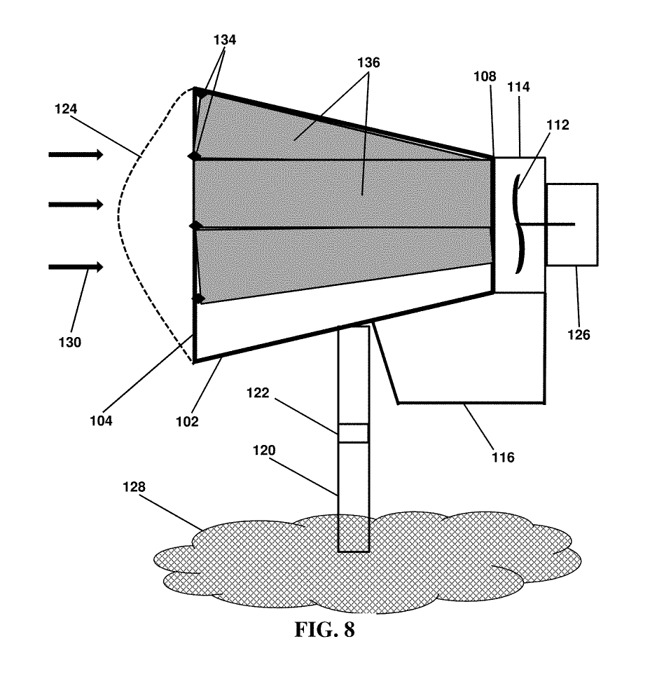

Referring now to FIGS. 8, 9, 10, and 11, these figures show an additional embodiment disclosing a wind power device 100 (essentially similar to previously described device 100) where cone 102 is provided with a plurality of sections or petals 136. Petals or sections 136 extend only partially about the periphery of cone 102 rather than over 360 degrees. The reason for this is that the bottom or lower section of cone 102 is attached to shaft 120 as well as to rotor housing 114 and mesh screen 124 and therefore does not deploy. Each petal section 136 is hinged by a pair of hinges 134 (as disclosed in FIGS. 8, 9, 10, and 11) to move in case of the occurrence of a high wind speed that is above the recommended speed for the wind power device.

FIG. 8 illustrates a side view where the wind power device embodiment's cone 102's side and upper sections 136 are hinged to move in case of high wind speed that is above the recommended speed for the wind power device. The wind direction is coming from left to right in FIG. 8. As a way to reduce the wind pressure and prevent damage to wind power device 100 if there is a very strong wind, the side and upper sections 136 of cone 102 would each have at least two hinges 134 that are positioned towards large front end 104 of cone 102.

Hinges 134 are powered by a motor and/or spring to enable the unfolding and folding of sections 136 of cone 102 so that when cone 102's sections 136 are fully deployed, like a flower opening its petals, cone 102 would more resemble a cylinder than a conical shape. It would be a partial cylinder as the lower section of cone 102 would not deploy as this bottom or lower section is connected to shaft 120 and housing 114.

Strong wind 130 would pass through cone 102 which would resemble a cylinder shape without damaging either cone 102's structure or rotor blades 112 or generator 126. With strong wind 130, cone 102's side and upper sections 136 would open up where hinges 134 are located, releasing the excess wind pressure on cone 102 so that cone 102 would not be structurally compromised. When strong wind 130 recedes below a certain wind speed, side and upper sections 136 of cone 102 would move back down into place at hinges 134 with the assistance of a motor and/or spring, and cone 102's shape would be restored to its original conical shape.

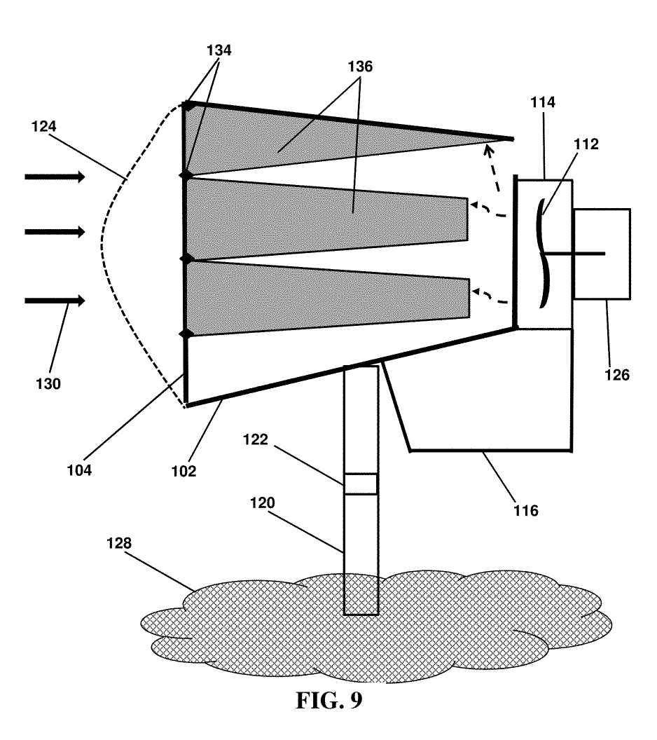

Referencing the additional embodiment depicted in FIG. 8, FIG. 9 shows a side view where the wind power device embodiment's cone 102's side and upper sections 136 that are hinged at hinges 134 are deployed like flower petals due to high wind speed that is above the recommended speed for the wind power device. The wind direction is coming from left to right in FIG. 9. Upper sections 136 attached at hinges 134 deploy outward away from back end 108 of cone 102 and side sections 136 attached at hinges 134 deploy outward away from back end 108 of cone 102.

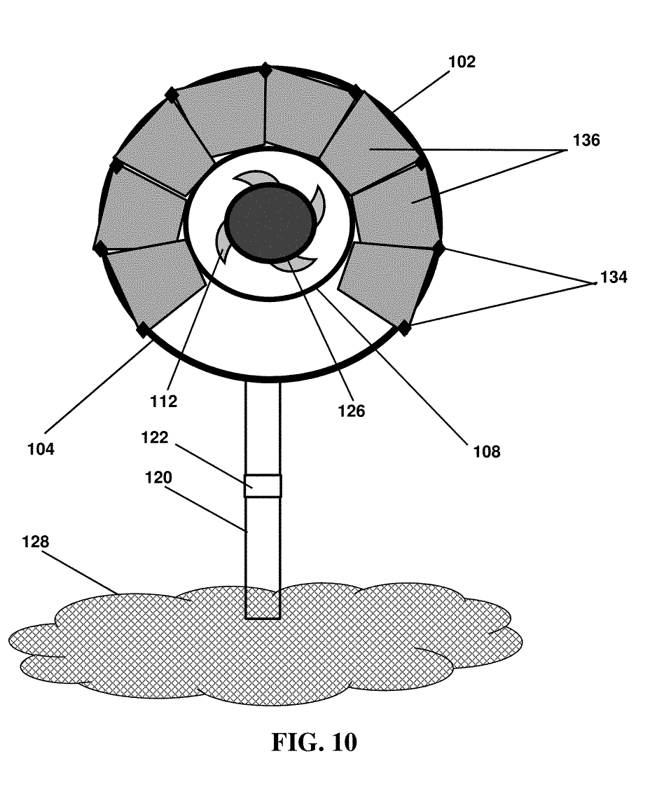

Referencing the additional embodiment depicted in FIG. 8, FIG. 10 shows the back view of the wind power device embodiment's cone 102 with side and upper sections 136 where the wind power device embodiment's cone 102's side and upper sections 136 are hinged at hinges 134 to move in case of high wind speed that is above the recommended speed for the wind power device. Sections 136 are sloped from large end 104 of cone 102 to small back end 108 of cone 102 as would be seen under normal wind conditions. The conical shape of cone 102 is intact and cone 102 resembles a cone as seen in FIG. 8.

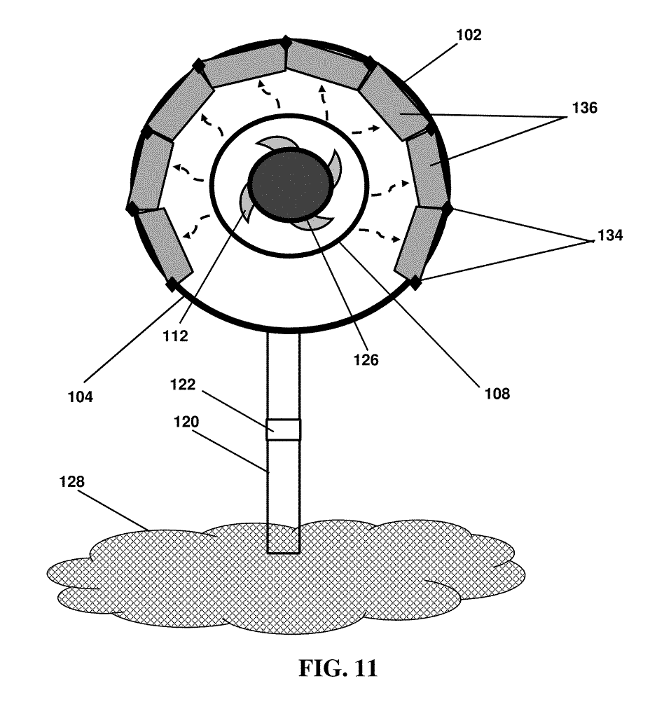

Referencing the additional embodiment depicted in FIG. 9, FIG. 11 shows the back view of the wind power device embodiment's cone 102 with side and upper sections 136 where the wind power device embodiment's cone 102's side and upper sections 136 are hinged at hinges 134 and are deployed like flower petals due to high wind speed that is above the recommended speed for the wind power device. Upper sections 136 attached at hinges 134 deploy outward away from back end 108 of cone 102 and side sections 136 attached at hinges 134 deploy outward away from back end 108 of cone 102.

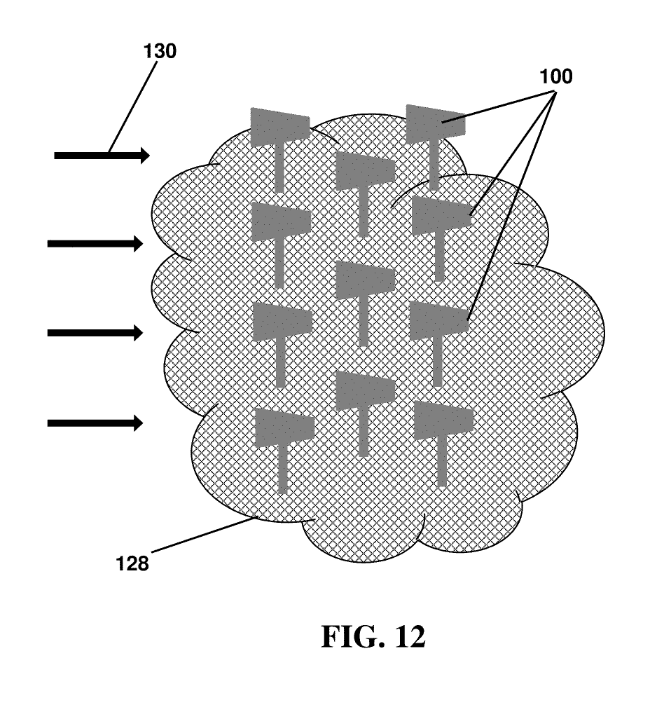

FIG. 12 depicts a wind farm utilizing multiple wind power devices 100 in location 128. The wind direction is coming from left to right in FIG. 12. To more efficiently generate electricity from wind, an array of wind power devices 100 would be set up in location 128. These could be positioned in hills, valleys, sides or tops of buildings, or flat land regions.

From the above, several conclusions, ramifications, and scope of the present invention can be understood.

The vortex wind power conversion device can be used in a variety of settings and made in a variety of sizes. The device can be used in large scale industrial applications such as on wind farms. Multiple devices spread along a high wind area could capture the wind power and convert it to electricity. It can be attached to commercial buildings and apartment buildings to capture the wind power for those structures. The device can also be attached to or set up close to residential homes to provide electricity for the homes.

Because the device is more wind efficient and effective than the prior art, it does not need to be set up on high structures like the prior art, but can be lower to the ground. This lower stance also reduces the environmental damage to birds and does not adversely affect the esthetic views of the landscape.

In windy areas such as in-between buildings or in high wind areas where wind can adversely affect the landscape (i.e. farms and other agricultural areas), these projects can help turn the wind into energy and reduce the adverse affects of the wind on the land (i.e. help prevent top soil erosion due to wind) and help prevent “dust bowls” like those in the 1920's and 1930's.

The project can be a toy or used for educational purposes to show how wind power works and how electricity works.

The device can be scaled to be large or small to be applied in a variety of settings. The cone device can be large size for wind farms, medium size for commercial uses, or smaller to be attached to or close to residential homes.

The cone and rotor can be made from carbon fiber, plastics, or fiberglass, aluminum, titanium, or some other lightweight material.

Although the invention has been described with respect to particular embodiments thereof, it should be realized that various changes and modifications may be made therein without departing from the spirit and scope of the invention.

What is claimed is:

1. A wind energy conversion system comprising:
(a) an open-ended hollow cone which has an entrance at one end of given diameter for receipt of wind and an exit of given diameter, wherein the entrance diameter is greater than that of the exit diameter;
(b) spiraled rifling inside said cone to direct the wind in a specified spiral direction;
(c) at least one fin attached adjacent to said cone exit;
(d) a rotor with a plurality of blades positioned at the smaller end of said cone;
(e) a generator coupled to said rotor;
whereby the wind accelerates through the assembly horizontally, and said cone intake is configured to receive, accelerate, and direct the wind.

2. The system according to claim 1 further comprising a mesh screen secured to said cone entrance for protecting the interior of said cone and for allowing the wind to pass through said screen, but for preventing birds, foreign objects, and debris from passing there-through.

3. The system according to claim 2 in which said mesh screen has a convex configuration.

4. The system according to claim 1 in which said cone interior has a smooth and gradual transition from its entrance to its exit.

5. The system according to claim 1 in which said cone is configured to receive the wind at an entrance wind velocity and to accelerate the received wind to an accelerated wind velocity.

6. The system according to claim 1 where said cone and said generator are operably coupled and balanced on a support structure to avoid the need for any mechanical or electric controller needed to turn said cone.

7. The system according to claim 1 further including a support column comprising a shaft supporting said cone, a base for said shaft and a pivot point whereby said base is disposed to contact the ground or a platform or a structure.

8. The system according to claim 1 further including a structure coupled to said cone and said generator for enabling their vertical rotation.

9. The system according to claim 1 further including an outer cover positioned about said rotor and wherein said fin is integrally formed at the bottom of said outer cover.

10. The system according to claim 9 wherein said fin is single and is perpendicularly installed on the surface of said outer cover.

11. The system according to claim 9 wherein said cone has a side profile and said fin is large enough to compensate for the side profile of said cone to have the wind orient said cone substantially to face into the wind to obtain an optimum flow of the wind.

12. The system according to claim 9 further including a second fin as a symmetrical twin to said first named fin and to be separately perpendicularly installed on the surface of said outer cover.

13. The system according to claim 9 wherein said second fin is integrally formed with the top of said outer cover.

14. The system according to claim 1 wherein said rifling in said cone spirals in from said cone entrance towards said cone exit in either a clockwise or counterclockwise direction.

15. The system according to claim 1 wherein said rifling in said cone runs the length of said cone from said cone entrance to said cone exit.

16. The system according to claim 1 wherein said rifling directs the wind in a cyclone-type manner.

17. The system according to claim 1 wherein said rifling is configured as one of indents and grooves into said cone or protrusions and ridges emanating from the inside of said cone.

18. The system according to claim 1 wherein the blades of the rotor are aligned with the direction of the rifling and rotate in a certain way depending on the clockwise or counterclockwise direction of the rifling.

19. The system according to claim 1 wherein said blades of the rotor are mounted in a fixed-angle way or adjustable-angle way.

20. The system according to claim 1 wherein said blades of the rotor have a rotor diameter which is less than the diameter of the passage of the small end of said cone.

21. The system according to claim 1 further including solar panels mounted on said cone, said generator, and said support structure to provide a second source of electrical power in addition to said generator.

22. The system according to claim 1 wherein said cone is divided into sections and hinges connecting said sections to said cone so that, in case of stronger wind speed, said cone opens up to resemble a cylinder.

23. The system according to claim 22 wherein said cone's lower section is not attached by hinges and does not deploy.

24. The system according to claim 22 wherein said cone's sections open and close at said hinges with the assistance of an electrical and/or mechanical attachment.

25. The system according to claim 1 wherein the wind energy conversion system is part of a wind farm comprising a plurality of the wind energy conversion systems.

26. A method for converting wind energy comprising the steps of:
(a) rotating a housing for positioning a cone shaped intake windward;
(b) collecting the wind into a channel having an inlet and an outlet;
(c) concentrating the collected wind in the channel;
(d) rifling the collected wind in the channel in a specific spiral direction;
(e) converting the concentrated wind into energy via a generator, the generator having blades positioned substantially normal to the flow of the concentrated wind, the generator having an axis stationary relative to the housing,
whereby the wind generator system is positioned about a horizontal axis and that the wind accelerates through the assembly horizontally, and the cone intake is configured to receive, accelerate, and direct the wind.
